(19) United States
(12) Patent Application Publication
(10) Pub. No.: US 2019/0183048 A1
(43) Pub. Date: Jun. 20, 2019

(54) Engine Speed Control and Ground Speed Control of a Hydraulically Driven Tractor

(71) Applicant: MacDon Industries Ltd., Winnipeg (CA)

(72) Inventors: Michael Flintoft, Winnipeg (CA); Benjamin Foster, Winnipeg (CA); Neil Barnett, Waunakee, WI (US)

(21) Appl. No.: 15/844,924

(22) Filed: Dec. 18, 2017

(51) Int. Cl. A01D 41/127; A01D 41/14; A01D 34/24; F02D 41/00; F02D 41/12

(52) U.S. Cl. CPC A01D 41/1274; A01D 41/141; A01D 34/246; F02D 2200/10; F02D 41/0097; F02D 41/12; A01D 41/142

(57) ABSTRACT

A hydraulically driven tractor has a header drive system including a header drive motor and a header drive pump driven by an engine for generating a source of hydraulic fluid under pressure for the header drive motor, and a ground drive system including a wheel drive motor and a wheel drive pump driven by the engine for generating a source of hydraulic fluid under pressure for the wheel drive motor. A controller receives input from sensors so as to monitor: a header drive demand value, a wheel drive demand value, an engine load value, and/or an engine RPM value for comparisons to acceptable threshold range to vary the target throttle value if outside of one of the ranges. The controller can also vary the displacement of the wheel drive pump and/or the wheel drive motor in response to variation of the target throttle value to maintain ground speed.

### FIELD OF THE INVENTION

The present invention relates to a hydraulically driven tractor of the type commonly but not necessarily used as a swather tractor, which is supported on a pair of hydraulically driven wheels, and which supports a hydraulically driven agricultural header thereon.

### RELATED PRIOR PATENTS

Reference is made to the following patents and applications by the same assignee, the disclosure of each of which is incorporated herein by reference as they disclose further details which may be used in the machines disclosed herein:

U.S. Pat. No. 8,985,252 (Otto) issued Mar. 24, 2015 which discloses speed and steering control of a hydraulically driven tractor.

U.S. Pat. No. 8,245,489 (Talbot) issued Aug. 21, 2012 which discloses a combine harvester where the header is carried on gauge wheels.

U.S. Pat. No. 8,225,903 (Dunn) issued Jul. 24 200712 which discloses a tractor of the type suitable for use herein where the tractor includes a suspension system.

U.S. Pat. No. 8,020,648 (Otto) issued Sep. 20, 2011 which discloses a tractor of the type suitable for use herein where the tractor has a rear suspension.

U.S. Pat. No. 7,958,706 (Remillard) issued Jun. 14, 2011 which discloses a tractor of the type suitable for use herein where the tractor includes a reel speed control.

U.S. Pat. No. 7,918,076 (Talbot) issued Apr. 5, 2011 which discloses a header of the type suitable for use herein where the header has three sections which include a balance of lifting forces across the three sections.

U.S. Pat. No. 7,721,830 (Dunn) issued May 25, 2010 which discloses a tractor of the type suitable for use herein with steering control.

U.S. Pat. No. 7,373,769 (Talbot) issued May 20, 2008 which discloses a header with a wear shield under the cutter bar.

U.S. Pat. No. 7,347,277 (Enns) issued Mar. 25, 2008 which discloses a header with a self-contained transport system.

U.S. Pat. No. 7,472,533 (Talbot) issued Jan. 6, 2009 which discloses a header with a cutter bar and draper with a seal between the draper and cutter bar.

U.S. Pat. No. 7,159,687 (Dunn) issued Jan. 9, 2007 which discloses a tractor of the type suitable for use herein where the tractor carries a header across a front face thereof for movement across the field for forming a swath from a standing crop where the tractor can be reversed in direction for transport.

### BACKGROUND

Windrowers are typically provided with controls which set the maximum engine speed in the field, however, this setting typically corresponds to operation of the machine at a level which has much more power than the harvesting function requires during normal operation. This results in an excess fuel consumption for operation of the engine at a higher speed than necessary. The higher speed of the engine also produces excess noise levels. The throttle control of the engine can be manually operated by the operator to reduce engine speed when higher engine speeds are not required, but this requires constant attention on the part of the operator which can further contribute to operator fatigue.

### SUMMARY OF THE INVENTION

According to one aspect of the invention there is provided a hydraulically driven tractor comprising:

a tractor frame supported on wheels;

an engine mounted on the tractor frame;

an agricultural header supported on the tractor frame;

a header drive system including (i) at least one header drive motor operatively connected to the agricultural header for driving the header, and (ii) a header drive pump driven by the engine for generating a source of hydraulic fluid under pressure, the header drive pump being operatively connected to the said at least one header drive motor for driving said at least one header drive motor;

a ground drive system including (i) at least one wheel drive motor operatively connected to a respective one of the wheels for driving the wheel, and (ii) at least one wheel drive pump driven by the engine for generating a source of hydraulic fluid under pressure, said at least one wheel drive pump being operatively connected to said at least one wheel drive motor for driving said at leas tone wheel drive motor;

an engine throttle control operating the engine at a target throttle value within a range of engine throttle values; and

a controller including a processor arranged to execute programming instructions stored thereon so as to be configured to:

(i) receive input from one or more sensors so as to monitor at least one of: (a) a header drive demand value representative of a load on the engine by the header drive pump, (b) a wheel drive demand value representative of a load on the engine by said at least one wheel drive pump, (c) an engine load value representative of a cumulative load on the engine by the header drive pump and said at least one wheel drive pump, and/or (d) an engine RPM value;

(ii) compare the at least one monitored value to a respective acceptable threshold range; and

(iii) vary the target throttle value if the at least one monitored value falls outside of the respective acceptable threshold range.

Reducing the throttle value to set the engine at a lower speed can save fuel, and reduce noise levels and operator fatigue. More engine power can be needed for short periods because of a hill, heavier crop loading, or soil conditions for example. Setting the machine to the lowest engine speed that can achieve the function, and have the windrower automatically adjust to cover periods where more power is required further optimises operation of the tractor.

The controller according to the present invention may monitor one or more functions of the tractor, for example ground speed, engine speed, engine load, and/or displacement of one or both of the hydraulic pump and motor. A measurement of header load or speed could also be done. The ground speed is set with a target value. The engine speed is also set to a speed by the operator that would allow the windrower/tractor to perform baseline work easily. The minimum speed the windrower could operate under these conditions could be configured by an operator, or set by the manufacturer. The operator could select target value ranges for header speed, header pressure, or engine load for example. The controller would monitor these values and if the values fall outside the selected range, the engine speed could be adjusted so that the values would return to within the range that is acceptable. As the engine speed is adjusted, a simultaneous adjustment would be made to displacement of the wheel drive pumps or motors so that the ground speed is maintained at a target set point as well. The displacement of the pump or motor could be adjusted based on a predetermined calibration based on engine speed.

The controller may be configured to reduce the target throttle value to a minimum target value that results in the at least one monitored value remaining within the respective acceptable threshold range. More particularly, the controller is preferably configured to reduce the target throttle value towards a prescribed minimum throttle value stored on the controller if the at least one monitored value remains within the respective acceptable threshold range. The prescribed minimum throttle value may be adjustable in response to operator input received from operator controls within an operator cab supported on the tractor frame.

In one configuration, the controller may be configured to receive input from one or more sensors relating to the wheel drive demand value and vary the target throttle value if the wheel drive demand value is outside of the respective acceptable threshold range for the wheel drive demand value. In this instance, the controller may be configured to receive input from one or more pressure sensors such that the wheel drive demand value corresponds to a hydraulic pressure value of hydraulic pressure of the at least one wheel drive pump. Preferably the respective acceptable threshold range for the wheel drive demand value is adjustable in response to operator input received from operator controls within an operator cab supported on the tractor frame.

In another configuration, the controller may be configured to receive input from one or more sensors relating to the header drive demand value and vary the target throttle value if the header drive demand value is outside of the respective acceptable threshold range for the header drive demand value. In this instance, the controller may be configured to (i) receive input from one or more pressure sensors such that the header drive demand value corresponds to a hydraulic pressure value of hydraulic pressure of the header drive pump, and/or (ii) receive input from one or more speed sensors associated with the header such that the header drive demand value corresponds to a header speed of the at least one header drive motor. Preferably the respective acceptable threshold range for the header drive demand value is adjustable in response to operator input received from operator controls within an operator cab supported on the tractor frame.

In another configuration, the controller may be configured to receive input from one or more sensors relating to the engine load value and vary the target throttle value if the engine load value is outside of the respective acceptable threshold range for the engine load value. Preferably the acceptable threshold range for the engine load value is adjustable in response to operator input received from operator controls within an operator cab supported on the tractor frame.

In yet another configuration, the controller may be configured to receive input from one or more sensors relating to the engine RPM value and vary the target throttle value if the engine RPM value is outside of the respective acceptable threshold range for the engine RPM value. Preferably the acceptable threshold range for the engine RPM value is adjustable in response to operator input received from operator controls within an operator cab supported on the tractor frame.

In another configuration, the controller may be configured to receive input from a plurality of the sensors, including various combinations of the sensors noted above, such that the input received relates to two or more of the monitored values. In this instance, the controller may be configured to vary the throttle value if any one of the monitored values falls outside of the respective acceptable threshold range.

According to a preferred embodiment, when the tractor further comprises (i) the at least one wheel drive pump being operable to vary a displacement of the wheel drive pump between a minimum and a maximum to vary the flow rate of the fluid generated for supply to the at least one wheel drive motor as the wheel drive pump is driven, and (ii) the at least one wheel drive motor being operable to vary a displacement of the wheel drive motor between a minimum and a maximum to vary a ground speed of the respective wheel relative to the flow rate of the fluid supplied to the wheel drive motor, the controller is preferably further configured to vary the displacement of the at least one wheel drive pump and/or the at least one wheel drive motor in response to variation of the target throttle value to maintain ground speed.

In one instance, the controller may be configured to maintain ground speed constant by varying the displacement of the at least one wheel drive motor in response to variation of the target throttle value. Alternatively, the controller may be configured to maintain ground speed constant by varying the displacement of the at least one wheel drive pump in response to variation of the target throttle value, or by a combination of varying displacement of both the drive motor and drive pump.

The controller is preferably configured to vary the displacement of the at least one wheel drive pump and/or the at least one wheel drive motor based upon a predetermined value related to the target throttle value, in which the predetermined value is stored on the controller.

Alternatively, the controller may be configured to receive input from a ground speed sensor relating to ground speed and vary the displacement of the at least one wheel drive pump and/or the at least one wheel drive motor to maintain the ground speed sensed by the ground speed sensor constant.

According to a second aspect of the present invention there is provided a hydraulically driven tractor comprising:

a tractor frame supported on wheels;

an engine mounted on the tractor frame;

an agricultural header supported on the tractor frame;

a header drive system including (i) at least one header drive motor operatively connected to the agricultural header for driving the header, and (ii) a header drive pump driven by the engine for generating a source of hydraulic fluid under pressure, the header drive pump being operatively connected to the said at least one header drive motor for driving said at least one header drive motor;

a ground drive system including (i) at least one wheel drive motor operatively connected to a respective one of the wheels for driving the wheel, and (ii) at least one wheel drive pump driven by the engine for generating a source of hydraulic fluid under pressure, said at least one wheel drive pump being operatively connected to said at least one wheel drive motor for driving said at least one wheel drive motor;

the at least one wheel drive pump being operable to vary a displacement of the wheel drive pump between a minimum and a maximum to vary the flow rate of the fluid generated for supply to the at least one wheel drive motor as the wheel drive pump is driven;

the at least one wheel drive motor being operable to vary a displacement of the wheel drive motor between a minimum and a maximum to vary a ground speed of the respective wheel relative to the flow rate of the fluid supplied to the wheel drive motor;

an engine throttle control operating the engine at a target throttle value within a range of engine throttle values; and

a controller including a processor arranged to execute programming instructions stored thereon so as to be configured to:
(i) receive input from one or more sensors so as to monitor at least one of: (a) a header drive demand value representative of a load on the engine by the header drive pump, (b) a wheel drive demand value representative of a load on the engine by said at least one wheel drive pump, (c) an engine load value representative of a cumulative load on the engine by the header drive pump and said at least one wheel drive pump, and/or (d) an engine RPM value;
(ii) compare the at least one monitored value to a respective acceptable threshold range;
(iii) vary the target throttle value if the at least one monitored value falls outside of the respective acceptable threshold range; and
(iv) vary the displacement of the at least one wheel drive pump and/or the at least one wheel drive motor in response to variation of the target throttle value to maintain ground speed.

### BRIEF DESCRIPTION OF THE DRAWINGS

One embodiment of the invention will now be described in conjunction with the accompanying drawings in which:

FIG. 1 is a top plan view partly in phantom and partly broken away showing a tractor of the type with which the present invention is concerned in a cab forward position; and

FIG. 2 is a schematic illustration of the control system for the tractor of FIG. 1.

In the drawings like characters of reference indicate corresponding parts in the different figures.

### DETAILED DESCRIPTION

A swather tractor generally indicated at 10 includes a frame 11 which is carried on a first pair of driven ground wheels 12 and 13 and on a second pair of non-driven castor wheels 14 and 15. The driven wheels 12 and 13 are mounted on suitable supports 16 which support the ground wheels from the frame 11. The driven ground wheels 12 and 13 are each driven by a hydraulic motor 17 carried on the support 16 which receives hydraulic fluid under pressure from a supply line and drives the ground wheel at a rate of rotation dependant upon the rate of flow of the hydraulic fluid. The displacement of the motors 17 is adjustable by a servo 17A and 17B which act to cause step-less or continuous adjustment of the displacement over a range between a maximum position in which the wheel moves at minimum ground speed for a certain flow rate of the fluid and a minimum position in which the wheel moves at maximum ground speed for a certain flow rate of the fluid. The servos 17A and 17B are controlled by a control unit 17C as described in more detail hereinafter.

The wheels 14 and 15 are mounted on conventional castors 18 which swivel about a castor pin 19. The ground wheels 14 and 15 are non-driven and are simply mounted in a supporting bracket 20 which can pivot around the castor pin 19 so that the castor wheels follow the movement of the vehicle as controlled by the driven wheels 12 and 13. Thus the speed of the vehicle over the ground is controlled by the rate of rotation of the wheels 12 and 13 and steering is controlled by a differential in speed between the wheels 12 and 13.

The frame is shown only schematically since this can vary widely in accordance with requirements as is well known to a person skilled in this art. At the driven end 11A of the frame is mounted suitable supports 21 and 22 for carrying a header 23. Again, these elements are well known to persons skilled in this art and various different designs can be used. Thus, the support elements 21, 22 on the header carried thereby are shown only schematically. Various different types of headers can be used including disc type cutters or sickle knife cutters 23A. The width of the header can vary considerably depending upon the type of crop and the cutting system employed. The header is preferably carried on the tractor rather than on separate supports and the tractor includes a lifting mechanism schematically indicated at 23 operable to raise and lower the header on the tractor between different working positions and between working positions and a raised position cleared from the ground for moving the header over the ground when not in working position.

The tractor includes an engine 24 carried on the frame 11 adjacent a second end 11B of the frame. The engine is arranged to drive a series of pumps 25, 26 and 27 for generating pressurized hydraulic fluid for driving the various components of the tractor as described hereinafter. Separate pumps can be used as shown or a single pump can be used with the hydraulic fluid under pressure generated thereby being separated into separate controlled fluid paths for operating the various components.

At the driven end 11A of the frame is provided a cab 30 which sits over the driven end between the driven wheels 12 and 13 so the operator can look over the header during the operating action on the field. The cab 30 encloses an operator console generally indicated at 31 which includes a seat 32, a steering control 33 in the form of a conventional steering wheel, a speed control 34 and an accessory control 35.

The steering wheel 33 is of a conventional nature and is mounted in the console in front of the seat by suitable mounting arrangements which allow the operator to enter the seat and be comfortably located on the seat behind the steering wheel. To the right hand of the operator is provided a speed control 34 generally in the form of a lever which can pivot forwardly and rearwardly between a reverse position at the rear, a neutral position at the center and a forward position at the front. In an intuitive manner, therefore, the operator can pull rearwardly on the lever for reverse and push forwardly on the lever for forward movement with the rate of the movement being controlled by the relative position of the lever along its sliding action. The speed control 34 has a first output 34A in the form of a mechanical linkage and a second output 34B in the form of an electrical signal generated for example by a potentiometer at the lever.

To the right hand of the operator, on the same lever as the speed control for convenient access to the operator's hand, is provided the accessory control 35.

Many of the above components are well known and conventional and can be found in many different designs of such tractors manufactured by a number of manufacturers including the present assignee. Further details of many of the components are described in the above listed related patents.

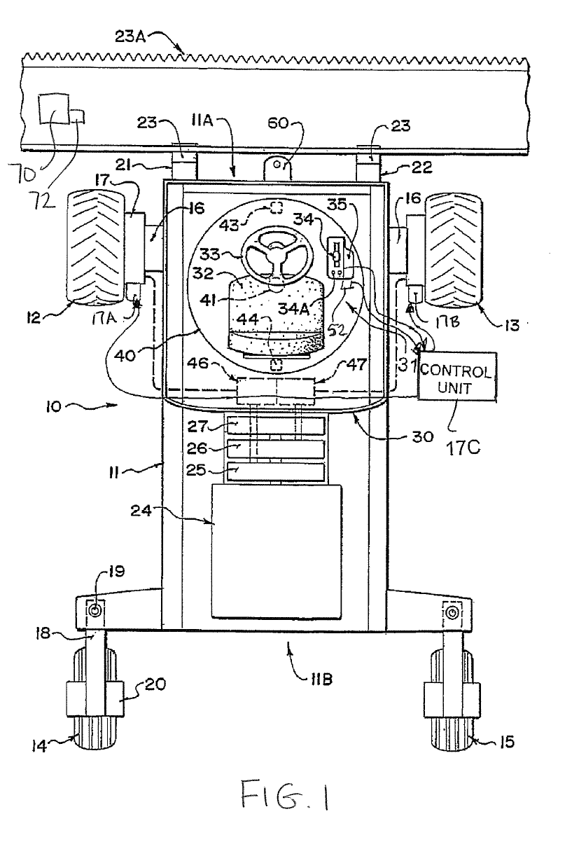

In the arrangement shown in this application, the operator console 31 including the operator seat 32, the steering wheel 33, the speed control 34 and the accessory control 35 are all carried on a platform or base plate 40 carried by the cab on top of the frame 11. The base plate 40 can rotate on a support shaft 41 about a vertical axis 42 between a first position shown in FIG. 1 where the seat faces the driven end 11A to the second position, not shown, in which the seat faces the engine end 11B. These positions are known herein as “cab forward” in which the cab 30 is located at the forward end of the tractor as it moves with the end 11A at the front and “engine forward” in which the end 11B is at the front and moves forwardly.

The positioning of the platform in the two positions is detected by a pair of switches 43 and 44 which co-operate with an element carried on the platform. Thus, only when the platform and the seating console are properly located and fixed in one of the selected positions, is this position detected by the respective switch 43, 44 which is used in the control system as set forth hereinafter. The speed control 34 and the accessory control 35 and the display board 32A are fixed relative to the seat and the platform so that they rotate with the platform. Thus, the operator in both positions has the controls arranged exactly in the same position for operation in an exactly symmetrical manner. Thus, the speed control works in the same manner in that rearward drives the vehicle toward the rear of the operator as the operator sees at the time and forward movement of the lever drives the lever forwardly in the orientation of the operator at the time. Mechanical and electrical coupling extend from the control systems including the steering, speed control and accessory control from the platform, through the support shaft 41 to a position underneath the frame where those communicating mechanical and electrical links cooperate with the relevant structures underneath the vehicle for controlling the movement of the vehicle. It will be appreciated that, when the operator is in the cab forward position shown in FIG. 1, movement of the speed control lever toward the end 11A moves the vehicle in the direction of the end 11A. When the seat is reversed, movement of the same lever in a direction away from the operator moves the lever toward the end 11B and must operate the tractor to move the vehicle along the direction toward the end 11B. This requires the linkage to be reversed since the effect of the lever must be reversed as the seat is rotated from one position to the other. This can be achieved by mechanical linkage or can be achieved by electrical and/or hydraulic connections as will be apparent to one skilled in the art.

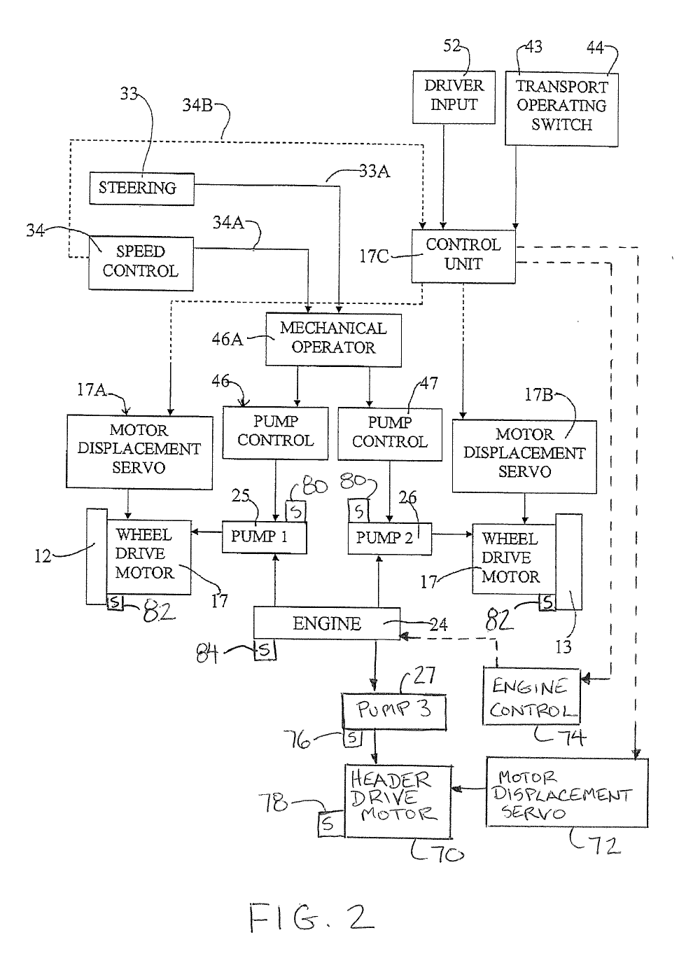

The mechanical section is shown in FIG. 1 and the schematic control system is shown in FIG. 2. The speed control system 34 controls through the linkage 34A the pumps 25 and 26 through pump controls 46 and 47. The pump 25 supplies fluid to the drive motor 17 of the wheel 12. The pump 26 supplies fluid to the motor 17 of the wheel 13. The pumps are controlled to control the displacement of the pumps and therefore the amount of fluid generated in a conventional manner. The rate of flow of fluid controls the rate of rotation of the respective motor so that the wheels rotate at a selected speed determined by the control of the pumps 25 and 26. The linkage 34A communicates with a linkage operator 46A which is designed to provide the required operation of the controls 46, 47. An example of the arrangement of this operator is shown in the above referenced U.S. Pat. No. 7,721,830. The pumps 25 and 26 together with the wheel drive motors 17 collectively define a ground drive system of the tractor.

In addition, the steering 33 controls the pumps 25 and 26 to generate a differential in the flow thereof so as to generate a differential in the speed of the motors 17. In the schematic illustration of a system shown in FIG. 3, this operation is shown as effected by a mechanical link 33A extending to the operator 46A so that the operator uses the input from the link 34A and from the link 33A to control the pumps 25 and 26 to control propulsion and steering in the manner set out for example in the above patent.

As shown in FIG. 2 the control unit 17C is also responsive to input from the seat switch sensors 43 and 44 so that operation of many of the systems shown in FIG. 2 is only possible when the seat switch is actuated indicating that the platform is in a selected one of the two positions. In addition, the indication from the respective seat switch of the selected position of the seat console is entered into the control unit to control the operation of the tractor in dependence of the cab forward or engine forward orientation, that is whether the tractor is in working mode or in transport mode.

The steering control 33 is arranged to vary the displacement of the hydraulic pumps not the hydraulic motors to vary a ground speed of the driven wheels differentially to cause steering of the tractor to a desired direction. Thus, the steering control 33 is arranged to vary the displacement of the first and second hydraulic pumps and not the first and second hydraulic motors.

The speed control lever 34 provides the control as described above of the first and a second hydraulic pumps 25, 26 to vary the displacement between a minimum and a maximum to vary the flow rate of fluid generated for supply to the first hydraulic motor as the first hydraulic pump is driven.

Each of the hydraulic drive motors 17 has a displacement which is continuously variable between a minimum and a maximum to vary a ground speed of the first driven wheel relative to a flow rate of the fluid supplied to the first hydraulic motor.

The speed control lever 34 is arranged to vary the displacement of both the hydraulic pumps 25, 26 and the hydraulic motors 17 to vary a ground speed of the driven wheel symmetrically to vary a common ground speed of the tractor by providing two separate output signals 34A, 34B where the first output 34B is used to control displacement of the first and second motors and the second output 34A is used to control displacement of the first and second pumps.

The first and second outputs is an electrical signal generated by the electrical sensor detecting movement of the speed control and can be conveniently provided by a potentiometer on the speed control lever which provides an output voltage proportional to the displacement of the lever by the tractor driver.

The second output is provided by the mechanical link 34A which uses conventional drive systems to operate the mechanical stroking of the pump. The electronic control system 17C includes a program arranged so that the adjustment generated by said electrical signal is not directly proportional to a position of the speed control lever as further described in U.S. Pat. No. 8,985,252.

The header 23 of the tractor 10 further includes a header drive motor 70 which receives a hydraulic flow of fluid from the pump 27 which acts as a header drive pump that generates pressurized hydraulic fluid for driving the header drive motor 70 which in turn drives operation of the sickle knife cutters 23A. A motor displacement servo 72 is associated with the header drive motor 70. In this manner the displacement of the motor is adjustable by the servo which acts to cause step-less or continuous adjustment of the displacement over a range between a maximum position in which the sickle knife cutter moves at a minimum speed for a certain flow rate of the fluid and a minimum position in which the sickle knife cutter moves at a maximum speed for a certain flow rate of the fluid. The servo 72 is controlled by the control unit 17C. The header drive motor 70 and the header drive pump 27 collectively define a header drive system of the tractor.

The control unit 17C is a computer type device including a memory storing programming instructions thereon and a processor for executing the programming instructions to perform the various functions described herein. In addition to controlling the displacement of the various motors and/or pumps, the control unit is also operatively connected to the engine 24 through an engine throttle control 74 which serves to operate the engine at a target throttle value within a range of engine throttle values. The target throttle value may be determined through driver input 52 into the control unit, or may be determined according to the programming instructions of the control unit.

Execution of the programming relies on data being input into the control unit through a variety of sensors which serve to monitor various operating values relating to the tractor. The following sensors are provided on the tractor according to the illustrated embodiment the illustrated embodiment.

A header pressure sensor 76 is supported on the header 23 which measures a pressure of hydraulic fluid supplied by the header drive pump 27 to the header drive motor 70 in which the pressure defines a value which may be indicative of header drive demands of the engine.

A header speed sensor 78 is also provided on the header in communication with the output of the header drive motor 70 or the sickle knife cutters 23A to produce a value based on the speed of operation of the sickle knife cutter in which the sensed value may also be indicative of header drive demands on the engine. Either one or both of the values produced by the sensors 76 and 78 may be used to represent the header drive demands upon the engine.

One or more wheel drive pressure sensors 80 can be associated with the wheel drive system to measure a pressure of hydraulic fluid supplied by the wheel drive pumps 25 and 26 to the wheel drive motors 17 respectively in which the pressure defines a value which may be indicative of wheel drive demands upon the engine.

The control unit can further receive input values representative of the header demand value and the wheel demand value and combine the values to produce a combined engine load value representative of the overall load by all of the pumps 25, 26 and 27 upon the engine.

A pair of wheel speed sensors 82 are associated with the two wheel drive motors 17 respectively for measuring the speed of rotation output by the motors for rotating the drive wheels 12 and 13 respectively. The wheel speed sensors 82 thus produce an output value representative of the ground speed of the tractor as the tractor is displaced across the ground.

An engine speed sensor 84 is operatively associated with the engine for monitoring the RPM (revolutions per minute) of the engine output. The corresponding engine RPM value is output by the sensor 84 to the control unit.

The communication of the control unit with the various displacement servos and further communication of the control unit with the pumps 25, 26 and 27 ensures that the displacement of each of the pumps and the motors is also known to the control unit for monitoring the respective displacement values thereof.

In operation, the ground speed of the tractor across the ground is initially dictated by the operator using the speed control 34 such that the control unit operates displacement of the pumps and motors to effectively drive the wheels at the prescribed ground speed dictated by the speed control.

The engine 24 is typically operated by the engine throttle control to operate at a target throttle value. In the absence of other corrections or an overriding driver input 52, the control unit operates the engine at a target throttle value which is initially set by the control unit to be a predetermined minimum throttle value that corresponds to a desired engine speed for performing baseline work by the tractor, that is operating the wheel drive motors and the header drive motor for harvesting under normal conditions.

The control unit in this instance includes additional programming instructions so that the control unit is configured to automatically vary the target throttle value at which the engine is operated if the monitored values determined by the sensors indicate that the output of the engine must be increased to meet increased demand placed upon the engine by one or both of the header drive motor or the wheel drive motors.

In order to perform this assessment, the control unit stores an acceptable threshold range thereon in association with each of the monitored values relating to the performance of the tractor. If the monitored values all remain within the respective acceptable threshold ranges, the control unit maintains the engine throttle control operating the engine at the predetermined minimum throttle value. In the event that any one of the monitored values falls outside of the acceptable threshold range however, the control unit varies the target throttle value.

In general, if any of the values indicative of drive demand or engine load exceed the respective acceptable threshold ranges, corrective action is taken to increase the target throttle value for increasing the output of the engine. Alternatively, if any of the speed sensors, for example the header speed, the ground speed, or the engines been fall below a corresponding acceptable threshold range, corrective action may be taken to increase the target throttle value, again for increasing the output of the engine.

The target throttle value is typically gradually increased while the monitored values are continued to be monitored and compared to the respective thresholds in real time such that the control unit ceases to increase the target throttle value once the monitored values return to being within the acceptable threshold ranges respectively. The control unit continues to attempt to reduce the engine throttle value towards the predetermined minimum throttle value provided that the monitored values remain within the respective acceptable threshold ranges.

Each of the acceptable threshold ranges is stored on the controller and is defined by at least one or both of a minimum threshold and a maximum threshold. The thresholds in each instance may be predetermined values stored permanently on the control unit, or alternatively may be adjustable values which can be adjusted within respective ranges by the operator through the driver input 52.

The operator may also dictate other overriding controls such as dictating a minimum engine RPM value at which the engine throttle control is permitted to operate the engine 24. The minimum engine RPM value in this instance is also stored on the control unit and can be adjusted by the operator through the driver input 52.

According to various embodiments of the invention, any one monitored value or any combination of the monitored values noted above may be used in determining if corrective action should be taken to adjust the target throttle value according to which the engine control 74 operates the engine 24.

The control unit is further configured, in response to each variation of the target throttle value, to compensate for the effect of varying the target throttle value at which the engine is operated on the ground speed of the tractor. Typically, this involves varying the displacement of the wheel drive pumps or the wheel drive motors in response to the variation of the target throttle value to maintain the ground speed at a constant.

In the preferred embodiment, a predetermined relationship between engine throttle values and ground speed according to the operation of the motor displacement servos is calibrated and stored on the control unit. In this manner, in response to a variation of the target throttle value, the control unit is able to vary the displacement of one or both of the wheel drive pumps and the wheel drive motors according to predetermined values to achieve a constant ground speed as the target throttle value of the engine is varied.

In an alternative arrangement, the monitored ground speed determined by the sensors 82 is used as an input so that whenever the control unit takes corrective action to vary the target throttle value, the control unit simultaneously takes further corrective action to vary the displacement of one or both of the wheel drive pumps and the wheel drive motors to achieve a constant ground speed as the target throttle value of the engine is varied. In this instance, as sensed ground speed varies from the target ground speed dictated by the speed control before the target throttle value was changed, the control unit varies the displacement of the wheel drive pumps in a manner which corresponds to returning the sensed ground speed back to the target ground speed.

As described herein, the engine control system operates the engine to maintain the engine automatically at the lowest possible rpm. The engine RPM is adjusted by monitoring one or more of the header drive demands, the traction drive demands of the windrower at a set ground speed, the engine load (by revving up to counter the engine pulling down if below peak power), and/or the engine RPM by increasing RPM once it falls below a minimum threshold. The impact of changing engine RPM on ground speed is compensated for to minimize operator disturbance. More particularly, as the engine RPM is increased under higher loads, the wheel motors would shift and increase displacement to minimize the increase in ground speed. This would allow speed to be generally maintained while increasing engine RPM in response to demands on the drives. This could also be done by accelerating with a drive by wire pump. As the engine RPM is decreased under later loads, the wheel motors would shift and decrease displacement to increase in ground speed. This would allow speed to be generally maintained while decreasing engine RPM in response to demands on the drives. This could also be done by decelerating with a drive by wire pump. The system would be activated or deactivated by an operator interface such as a display and/or console buttons. The aggressiveness of the system may be adjustable by operator input in addition to providing an adjustable minimum engine RPM.

Since various modifications can be made in my invention as herein above described, and many apparently widely different embodiments of same made, it is intended that all matter contained in the accompanying specification shall be interpreted as illustrative only and not in a limiting sense.

1. A hydraulically driven tractor comprising:
a tractor frame supported on wheels;
an engine mounted on the tractor frame;
an agricultural header supported on the tractor frame;
a header drive system including (i) at least one header drive motor operatively connected to the agricultural header for driving the header, and (ii) a header drive pump driven by the engine for generating a source of hydraulic fluid under pressure, the header drive pump being operatively connected to the said at least one header drive motor for driving said at least one header drive motor;
a ground drive system including (i) at least one wheel drive motor operatively connected to a respective one of the wheels for driving the wheel, and (ii) at least one wheel drive pump driven by the engine for generating a source of hydraulic fluid under pressure, said at least one wheel drive pump being operatively connected to said at least one wheel drive motor for driving said at least one wheel drive motor;
an engine throttle control operating the engine at a target throttle value within a range of engine throttle values; and
a controller including a processor arranged to execute programming instructions stored thereon so as to be configured to:
(i) receive input from one or more sensors so as to monitor at least one of: (a) a header drive demand value representative of a load on the engine by the header drive pump, (b) a wheel drive demand value representative of a load on the engine by said at least one wheel drive pump, (c) an engine load value representative of a cumulative load on the engine by the header drive pump and said at least one wheel drive pump, and/or (d) an engine RPM value;
(ii) compare the at least one monitored value to a respective acceptable threshold range; and
(iii) vary the target throttle value if the at least one monitored value falls outside of the respective acceptable threshold range.

2. The tractor according to claim 1 wherein the controller is further configured to reduce the target throttle value to a minimum target value which results in the at least one monitored value remaining within the respective acceptable threshold range.

3. The tractor according to claim 1 wherein the controller is further configured to reduce the target throttle value towards a prescribed minimum throttle value stored on the controller if the at least one monitored value remains within the respective acceptable threshold range.

4. The tractor according to claim 3 wherein the prescribed minimum throttle value is adjustable in response to operator input received from operator controls within an operator cab supported on the tractor frame.

5. The tractor according to claim 1 wherein the controller is configured to receive input from one or more sensors relating to the wheel drive demand value and vary the target throttle value if the wheel drive demand value is outside of the respective acceptable threshold range for the wheel drive demand value.

6. The tractor according to claim 5 wherein the controller is configured to receive input from one or more pressure sensors such that the wheel drive demand value corresponds to a hydraulic pressure value of hydraulic fluid pressure provided by the at least one wheel drive pump to the at least one wheel drive motor.

7. The tractor according to claim 5 wherein the respective acceptable threshold range for the wheel drive demand value is adjustable in response to operator input received from operator controls within an operator cab supported on the tractor frame.

8. The tractor according to claim 1 wherein the controller is configured to receive input from one or more sensors relating to the header drive demand value and vary the target throttle value if the header drive demand value is outside of the respective acceptable threshold range for the header drive demand value.

9. The tractor according to claim 8 wherein the controller is configured to receive input from one or more pressure sensors such that the header drive demand value corresponds to a hydraulic pressure value of hydraulic fluid pressure provided by the header drive pump to the header drive motor.

10. The tractor according to claim 8 wherein the controller is configured to receive input from one or more speed sensors associated with the header such that the header drive demand value corresponds to a header speed of the at least one header drive motor.

11. The tractor according to claim 8 wherein the respective acceptable threshold range for the header drive demand value is adjustable in response to operator input received from operator controls within an operator cab supported on the tractor frame.

12. The tractor according to claim 1 wherein the controller is configured to receive input relating to the engine load value and vary the target throttle value if the engine load value is outside of the respective acceptable threshold range for the engine load value.

13. The tractor according to claim 12 wherein the acceptable threshold range for the engine load value is adjustable in response to operator input received from operator controls within an operator cab supported on the tractor frame.

14. The tractor according to claim 1 wherein the controller is configured to receive input from one or more sensors relating to the engine RPM value and vary the target throttle value if the engine RPM value is outside of the respective acceptable threshold range for the engine RPM value.

15. The tractor according to claim 14 wherein the acceptable threshold range for the engine RPM value is adjustable in response to operator input received from operator controls within an operator cab supported on the tractor frame.

16. The tractor according to claim 1 wherein the controller is configured to receive input from a plurality of the sensors relating to two or more of the values and vary the throttle value if any one of the monitored values falls outside of the respective acceptable threshold range.

17. The tractor according to claim 1 further comprising:
the at least one wheel drive pump being operable to vary a displacement of the wheel drive pump between a minimum and a maximum to vary the flow rate of the fluid generated for supply to the at least one wheel drive motor as the wheel drive pump is driven;
the at least one wheel drive motor being operable to vary a displacement of the wheel drive motor between a minimum and a maximum to vary a ground speed of the respective wheel relative to the flow rate of the fluid supplied to the wheel drive motor;
the controller being further configured to vary the displacement of the at least one wheel drive pump and/or the at least one wheel drive motor in response to variation of the target throttle value to maintain ground speed.

18. The tractor according to claim 17 wherein the controller is configured to maintain ground speed constant by varying the displacement of the at least one wheel drive motor in response to variation of the target throttle value.

19. The tractor according to claim 17 wherein the controller is configured to maintain ground speed constant by varying the displacement of the at least one wheel drive pump in response to variation of the target throttle value.

20. The tractor according to claim 17 wherein the controller is configured to vary the displacement of the at least one wheel drive pump and/or the at least one wheel drive motor based upon a predetermined value related to the target throttle value, the predetermined value being stored on the controller.

21. The tractor according to claim 17 wherein the controller is configured to receive input from a ground speed sensor relating to ground speed and vary the displacement of the at least one wheel drive pump and/or the at least one wheel drive motor to maintain the ground speed sensed by the ground speed sensor constant.

22. A hydraulically driven tractor comprising:
a tractor frame supported on wheels;
an engine mounted on the tractor frame;
an agricultural header supported on the tractor frame;
a header drive system including (i) at least one header drive motor operatively connected to the agricultural header for driving the header, and (ii) a header drive pump driven by the engine for generating a source of hydraulic fluid under pressure, the header drive pump being operatively connected to the said at least one header drive motor for driving said at least one header drive motor;
a ground drive system including (i) at least one wheel drive motor operatively connected to a respective one of the wheels for driving the wheel, and (ii) at least one wheel drive pump driven by the engine for generating a source of hydraulic fluid under pressure, said at least one wheel drive pump being operatively connected to said at least one wheel drive motor for driving said at least one wheel drive motor;
the at least one wheel drive pump being operable to vary a displacement of the wheel drive pump between a minimum and a maximum to vary the flow rate of the fluid generated for supply to the at least one wheel drive motor as the wheel drive pump is driven;
the at least one wheel drive motor being operable to vary a displacement of the wheel drive motor between a minimum and a maximum to vary a ground speed of the respective wheel relative to the flow rate of the fluid supplied to the wheel drive motor;
an engine throttle control operating the engine at a target throttle value within a range of engine throttle values; and
a controller including a processor arranged to execute programming instructions stored thereon so as to be configured to:
(i) receive input from one or more sensors so as to monitor at least one of: (a) a header drive demand value representative of a load on the engine by the header drive pump, (b) a wheel drive demand value representative of a load on the engine by said at least one wheel drive pump, (c) an engine load value representative of a cumulative load on the engine by the header drive pump and said at least one wheel drive pump, and/or (d) an engine RPM value;
(ii) compare the at least one monitored value to a respective acceptable threshold range;
(iii) vary the target throttle value if the at least one monitored value falls outside of the respective acceptable threshold range; and
(iv) vary the displacement of the at least one wheel drive pump and/or the at least one wheel drive motor in response to variation of the target throttle value to maintain ground speed.
